(19) United States
(12) Patent Application Publication
(10) Pub. No.: US 2023/0019740 A1
(43) Pub. Date: Jan. 19, 2023

(54) APPARATUS, METHOD, AND COMPUTER PROGRAM FOR PERFORMING SPH-BASED FLUID ANALYSIS SIMULATION

(71) Applicant: E8IGHT CO., LTD, Seongnam-si Gyeonggi-do (KR)

(72) Inventors: Sang Min SONG, Yongin-si Gyeonggi-do (KR); Eun Su KIM, Seongnam-si Gyeonggi-do (KR); Si Woo LEE, Seoul (KR)

(73) Assignee: E8IGHT CO., LTD, Seongnam-si Gyeonggi-do (KR)

(21) Appl. No.: 17/784,674

(22) PCT Filed: Dec. 27, 2019
(86) PCT No.: PCT/KR2019/018583

§ 371 Date: Jun. 13, 2022

(30) Foreign Application Priority Data
Dec. 13, 2019 (KR) 10-2019-0166623

(51) Int. Cl. G06F 30/28

(52) U.S. Cl. CPC G06F 30/28; G06F 2113/08

(57) ABSTRACT

A smoothed-particle hydrodynamics (SPH)-based fluid analysis simulation apparatus comprises: an input unit for receiving, as an input, data about a plurality of particles, for a fluid analysis simulation; a space formation unit that divides, into a plurality of cells, the space in which the plurality of particles are present, and generates cell indexes on the basis of the locations of the cells in the space where the plurality of particles are present; a particle search unit for searching for at least one neighboring particle that neighbors a target particle, on the basis of particle reference information about the plurality of particles and cell reference information about the plurality of cells; and a flow data calculation unit that calculates flow data between the target particle and the at least one neighboring particle, and performs a fluid simulation on the basis of the flow data for the plurality of particles.

### BACKGROUND OF THE DISCLOSURE

### Technical Field

The present invention relates to an apparatus, a method, and a computer program for performing a smoothed particle hydrodynamics (SPH)-based fluid analysis simulation.

### Background Art

Computational fluid dynamics (CFD) as a field of fluid dynamics calculates a dynamic motion of a fluid using a computer in a numerical analytical method. The CFD calculates the flow of the fluid by discretizing a Naiver-Stokes Equation which is a partial differential equation through methods such as Finite Difference Method (FDM), Finite Element Method (FEM), Finite Volume Method (FVM), and Smoothed Particle Hydrodynamics (SPH).

There are two methods for calculating the Navier-Stokes equation: a grid-based method that discretizes a spatial domain into a small mesh or grid, and a particle-based method that expresses a fluid as a set of multiple particles.

In the particle-based method, a more natural simulation of natural or physical phenomena is possible by expressing an analysis target as particles instead of using a grid. The particle-based method includes Smoothed Particle Hydrodynamics (SPH), Moving Particle Semi-implicit (MPS), Lattice Boltzmann Method (LBM), etc.

A Smoothed Particle Hydrodynamics (SPH)-based fluid analysis, which is one of the particle-based methods, can simulate the results of the analysis relatively quickly because the step of generating the grid is omitted, unlike the grid-based method.

In addition, since the SPH-based fluid analysis performs the analysis by using particles without generating the grid, analysis of free surfaces such as liquid-gas interfaces can be performed relatively easily.

Further, the SPH-based fluid analysis can perform relatively accurate analysis of multiphase flows including two or more of gas, liquid, and solid.

Due to the advantages, recently, SPH has been widely used in simulating the flow of the fluid.

However, in the case of simulation using a plurality of processors, in order to efficiently use each processor, a process of exchanging particle information between the plurality of processors is required.

Meanwhile, Korean Patent Registration No. 1700829 discloses a configuration for searching for neighboring particles of each particle on a cell-by-cell basis and a configuration for distributing cells to several computing devices.

### SUMMARY OF THE DISCLOSURE

An object of the present invention is to provide an apparatus, a method, and a computer program for performing a fluid analysis simulation that can search for adjacent particles.

An object of the present invention is to provide an apparatus, a method, and a computer program for performing a fluid analysis simulation that use a plurality of processors.

However, a technical object to be achieved by the embodiment of the present invention is not limited to the technical objects and there may be other technical objects.

As a means for achieving the technical object, an embodiment of the present invention may provide a smoothed particle hydrodynamics (SPH)-based fluid analysis simulation apparatus using a plurality of processors, which includes: a first processor; and a second processor, in which the first processor partitions a first space allocated to the first processor into a plurality of cells, generates first cell reference information based on information on the plurality of cells into which the first space is partitioned, generates first particle reference information based on information on a particle included in the first space, the second processor partitions into a second space allocated to the second processor into the plurality of cells, generates second cell reference information based on information on the plurality of cells into which the second space is partitioned, and generates second particle reference information based on information on the particle included in the second space, and the first processor and the second processor exchange the plurality of particles based on the first cell reference information, the first particle reference information, the second cell reference information, and the second particle reference information, calculate flow data between the plurality of exchanged particles, and performs a fluid simulation based on the flow data.

In an embodiment, the first processor may include a particle information generation unit generating the first particle reference information based on location information of the plurality of particles and a cell index for the first space, and a cell information generation unit generating the first cell reference information including inclusion information generated based on each cell index and the number of particles included a cell corresponding to each cell index.

In an embodiment, the cell reference information may further include accumulation information based on the number of particles included in a cell corresponding to a cell index before each cell index.

In an embodiment, the fluid analysis simulation apparatus may further include a third processor, and the third processor may include a cell management unit including an integrated cell information generation unit generating integrated cell reference information based on the first cell reference information and the second cell reference information, and a particle management unit including an integrated particle information generation unit generating integrated particle reference information based on the first particle reference information and the second particle reference information.

In an embodiment, the cell management unit may further include a region allocation unit deriving the number of particles positioned in the first space and the number of particles positioned in the second space based on the integrated cell reference information, and allocating the first space to the first processor and allocating the second space to the second processor based on the number of particles positioned in the first space and the number of particles positioned in the second space.

In an embodiment, the particle management unit may further include a particle exchange unit confirming an exchange target particle based on the second cell reference information, extracting information on the exchange target particle from the second particle reference information based on accumulation information of the second cell reference information, and instructing movement of the exchange target particle to the first processor based on the information on the exchange target particle.

In an embodiment, the first processor may further include a particle exchange performing unit receiving data regarding the exchange target particle from the second processor.

In an embodiment, the particle information generation unit may update the first particle reference information based on the information on the exchange target particle and the cell information generation unit may update the first cell reference information based on the information on the exchange target particle.

In an embodiment, the first and second processors may be graphics processing units (GPU) and the third processor may be a central processing unit (CPU).

Another embodiment of the present invention may provide a fluid analysis simulation method performed by a smoothed particle hydrodynamics (SPH)-based fluid analysis simulation apparatus including a first processor and a second processor, which includes: partitioning, by the first processor, a first space allocated to the first processor into a plurality of cells; generating, by the first processor, first cell reference information based on information on the plurality of cells into which the first space is partitioned; generating, by the first processor, first particle reference information based on information on a particle included in the first space; partitioning, by the second processor, a second space allocated to the second processor into the plurality of cells; generating, by the second processor, second cell reference information based on information on the plurality of cells into which the second space is partitioned; generating, by the second processor, second particle reference information based on information on a particle included in the second space; exchanging, by each of the first processor and the second processor, the plurality of particles based on the first cell reference information, the first particle reference information, the second cell reference information, and the second particle reference information; and calculating, by each of the first processor and the second processor, flow data between the plurality of exchanged particles, and performing a fluid simulation based on the flow data.

Another embodiment of the present invention may provide a computer program stored in a medium including a sequence of instructions of performing a smoothed particle hydrodynamics (SPH)-based fluid analysis simulation using a plurality of processors in which when the computer program is executed by a computing device, the plurality of processors includes a first processor and a second processor, divides an analysis space into a first space and a second space, allocates the first space to the first processor, and allocates the second space to the second processor, and includes a sequence of instructions of instructing partitioning, by the first processor, the first space into a plurality of cells, generating, by the first processor, first cell reference information based on information on the plurality of cells into which the first space is partitioned, generating, by the first processor, first particle reference information based on information on a particle included in the first space, partitioning, by the second processor, the second space into the plurality of cells, generating, by the second processor, second cell reference information based on information on the plurality of cells into which the second space is partitioned, generating, by the second processor, second particle reference information based on information on a particle included in the second space, and exchanging, by each of the first processor and the second processor, the plurality of particles based on the first cell reference information, the first particle reference information, the second cell reference information, and the second particle reference information, and calculating, by each of the first processor and the second processor, flow data between the plurality of exchanged particles, and performing a fluid simulation based on the flow data.

The problem solving means is just exemplary, and should not be interpreted as an intention of limiting the present invention. In addition to the exemplary embodiment, an additional embodiment may exist, which is disclosed in drawings and a detailed description of the present invention.

According to any one of the technical solutions of the present invention, it is possible to provide an apparatus, a method, and a computer program for performing a fluid analysis simulation which are capable of quickly searching for neighboring particles and efficiently exchanging information between a plurality of processors.

In addition, it is possible to reduce the time required for performing the fluid analysis simulation for a complex structure, a wide space, and the like by using the plurality of processors.

In addition, by effectively predicting the movement of a fluid using the plurality of processors, the preset invention can be applied to various technical fields.

### BRIEF DESCRIPTION OF THE DRAWINGS

FIG. 1 is a block diagram of a fluid analysis simulation apparatus using a plurality of processors according to an embodiment of the present invention.

FIG. 2 is a block diagram of a fluid analysis simulation apparatus according to an embodiment of the present invention.

FIG. 3 exemplarily illustrates a process of generating particle reference information and cell reference information according to an embodiment of the present invention.

FIG. 4 is a diagram for describing a method for searching for a neighboring particle according to an embodiment of the present invention.

FIG. 5 exemplarily illustrates particle reference information and cell reference information generated by each of a plurality of processors according to an embodiment of the present invention.

FIG. 6 exemplarily illustrates a process of generating integrated cell reference information and integrated particle reference information according to an embodiment of the present invention.

FIG. 7 is a diagram for describing a process in which a plurality of processors exchange particles with each other according to an embodiment of the present invention.

FIG. 8 is a diagram for describing a process in which a plurality of processors exchange particles with each other according to an embodiment of the present invention.

FIG. 9 is a flowchart of a fluid analysis simulation method according to an embodiment of the present invention.

### DETAILED DESCRIPTION OF THE DISCLOSURE

Hereinafter, embodiments of the present invention will be described in detail so as to be easily implemented by those skilled in the art, with reference to the accompanying drawings. However, the present invention may be modified in various different ways, all without departing from the spirit or scope of the present invention. In addition, in the drawings, in order to clearly describe the present invention, a part not related to the description is not omitted and like reference numerals designate like elements throughout the specification.

Throughout the specification, when it is described that a part is “connected” with another part, it means that the part may be “directly connected” with the another part and the parts may be “electrically or mechanically connected” to each other with still another element interposed therebetween. Further, when a part “includes” a component, it means that other components may be further included, rather than excluding other components, unless otherwise stated, and one or more other features, and it is to be understood that the existence or addition of numbers, steps, operations, components, parts, or combinations thereof is not precluded in advance.

In this specification, a “part” includes a unit realized by hardware, a unit realized by software, and a unit realized using both. In addition, one unit may be implemented using two or more hardware, and two or more units may be implemented by one hardware. Meanwhile, ‘part’ is not a meaning limited to the software or hardware and ‘part’ may be configured to be positioned in a storage medium which is addressable or configured to reproduce one or more processors. Accordingly, as one example, the “unit” includes components such as software components, object oriented software components, class components, and task components, processes, functions, attributes, procedures, subroutines, segments of a program code, drivers, firmware, microcodes, circuitry, data, databases, data structures, tables, arrays, and variables. Functions provided in the components and the “units” may be combined into a smaller number of components and “units” or further separated into additional components and “units”. Moreover, the components and the ‘units’ may be implemented to reproduce one or more CPUs in a device or a secure multimedia card.

Some of the operations or functions described as being performed by a terminal or device in this specification may be instead performed by a server connected to the terminal or device. Similarly, some of the operations or functions described as being performed by the server may also be performed in a terminal or device connected to the server.

Hereinafter, an embodiment of the present invention will be described in detail with reference to the accompanying drawings.

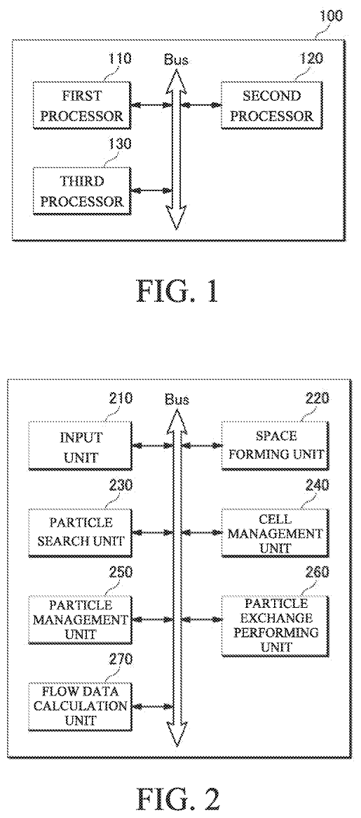

FIG. 1 is a block diagram of a fluid analysis simulation apparatus using a plurality of processors according to an embodiment of the present invention. FIG. 1 exemplarily illustrates the plurality of processors included in the fluid analysis simulation apparatus. Referring to FIG. 1, the fluid analysis simulation apparatus 100 may include a first processor 110, a second processor 120, and a third processor 130. However, the number of processors which may be included in the fluid analysis simulation apparatus 100 may include may be less or more than the case illustrated in FIG. 1.

The fluid analysis simulation apparatus 100 may include a server, a desktop, a notebook computer, a KIOSK, and a smartphone, and a tablet PC. However, the fluid analysis simulation apparatus 100 is not limited to the exemplified apparatuses above. That is, the fluid analysis simulation apparatus 100 may include all devices equipped with a processor for performing an SPH-based fluid analysis simulation method to be described later.

The fluid analysis simulation apparatus 100 performs a three-dimensional flow analysis of the fluid. That is, the fluid analysis simulation apparatus 100 models a three-dimensional simulation region and a plurality of particles positioned in the three-dimensional simulation region, and analyzes the flow of the plurality of particles in the three-dimensional simulation region. However, in the present specification, for convenience of description, the simulation region and particles are expressed and described in two dimensions.

The fluid analysis simulation apparatus 100 may perform a simulation for analyzing a fluid based on smoothed particle hydrodynamics (SPH). The Smoothed Particle Hydrodynamics (SPH) is one of the particle-type fluid analysis techniques which may be used in Computational Fluid Dynamics (CFD). In order to simulate the motion of the fluid, the SPH may express a fluid to be analyzed as one or more particles. The SPH may calculate a physical quantity of each particle while tracking each particle, and perform the fluid analysis simulation based on the calculation result.

The first processor 110, the second processor 120, and the third processor 130 may each be an information processing device capable of performing an independent computing operation. One of the first processor 110, the second processor 120, and the third processor 130 may transmit information to the other or receive information from the other. In an embodiment, the first processor 110 and the second processor 120 may be a graphics processing unit (GPU), and the third processor 130 may be a central processing unit (CPU).

Referring to FIG. 2, the fluid analysis simulation apparatus 100 may include an input unit 210, a space forming unit 220, a particle search unit 230, a cell management unit 240, a particle management unit 250, and a particle exchange performing unit 260, and a flow data calculation unit 270.

In an embodiment, each of the first processor 110 and the second processor 120 may include the space forming unit 220, the particle search unit 230, the particle exchange performing unit 260, and the flow data calculation unit 270, and the third processor 130 may include the input unit 210, the cell management unit 240, and the particle management unit 250. However, the configuration of each of the processors 110, 120, and 130 included in the fluid analysis simulation apparatus 100 is not limited thereto.

The input unit 210 may receive data regarding a plurality of particles for the fluid analysis simulation. For example, the input unit 210 may receive the data regarding the plurality of particles from an external device such as a user terminal.

The input unit 210 may also receive the data regarding the plurality of particles through communication with an external server. The data regarding the plurality of particles may include information regarding the analysis target required for performing the fluid analysis simulation. The data regarding the plurality of particles may include information on physical properties of each particle, and may include, for example, at least one of a particle radius, mass, density, viscosity, a velocity, an acceleration, and a location of each particle.

The fluid analysis simulation apparatus 100 may further include a modeling unit (not illustrated). The modeling unit may generate a structure model in which the plurality of particles are positioned. The modeling unit may generate, for example, a mesh-based structure model including a plurality of polygons. The modeling unit may generate the plurality of particles based on a location (center coordinate) and a particle radius of each particle. The structure model may also be generated based on a mesh constituted by a plurality of triangles, for example.

The space forming unit 220 may be partition a space in which the plurality of particles exist into a plurality of cells. The space forming unit 220 may generate a cell index based on the location of the cell in the space in which the plurality of particles exist.

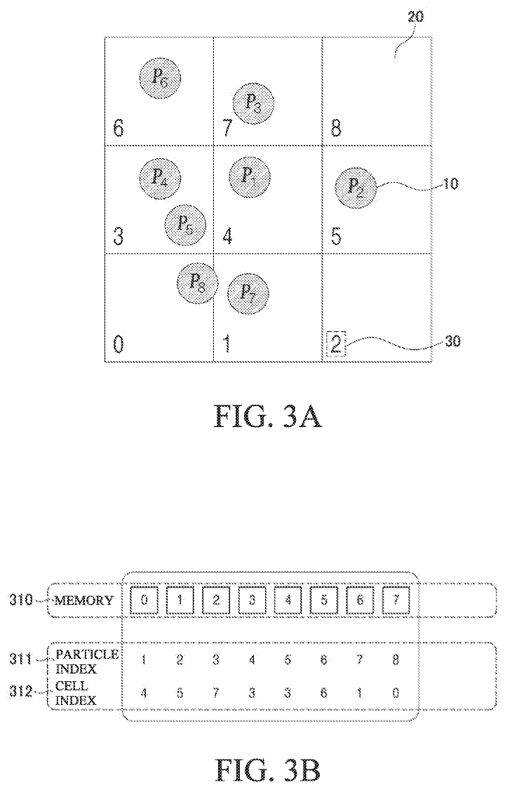

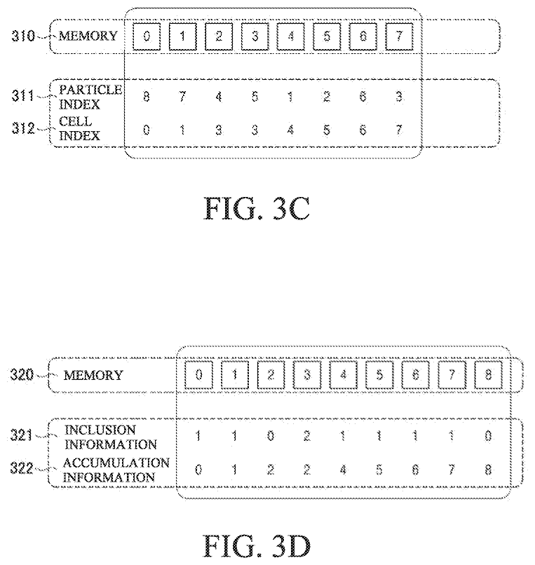

Referring to FIG. 3A, the space forming unit 220 may partition a space in which a plurality of particles 10 exist into a plurality of cells 20. The space forming unit 220 may determine a size of the cell 20 based on a radius of the particle 10. The space forming unit 220 may generate a cell index 30 which is a unique number granted to each of the plurality of cells 20. For example, when the space in which the plurality of particles 10 exist is partitioned into nine cells 20, one of numbers 0 to 8 is granted to each cell 20 in order based on the location of the cell 20 in the space to generate the cell index 30.

The space forming unit 220 may generate a particle index which is the unique number granted to each of the plurality of particles. Referring back to FIG. 3A, when data regarding the eight particles 10 is received, the space forming unit 220 may generate the particle index by granting one of the numbers 0 to 7 to each particle in order, for example.

In another embodiment, the particle index may be included in data regarding the plurality of particles received by the input unit 210.

The particle search unit 230 may search for at least one neighboring particle adjacent to a target particle in a space in which the plurality of particles exists. The particle search unit 230 may include a particle information generation unit (not illustrated) and a cell information generation unit (not illustrated).

The particle information generation unit may generate particle reference information regarding the plurality of particles. The particle information generation unit may secure a memory based on the number of plurality of particles before generating the particle reference information.

The particle information generation unit may generate the particle reference information based on location information and the cell indexes of the plurality of particles. The particle reference information may include, for example, the particle index and a cell index included in a particle corresponding thereto.

FIGS. 3A and 3B are diagrams for describing a process of generating the particle reference information. As illustrated in FIG. 3B, the particle information generation unit may secure a memory 310 capable of storing eight pieces of information, corresponding to the number of plurality of particles, before generating the particle reference information.

Referring to FIG. 3B, the particle information generation unit may generate particle reference information including a particle index 311 and a cell index 312 including a particle corresponding thereto. For example, the particle information generation unit may generate particle reference information including a particle index ‘3’ and a cell index ‘7’ including a particle corresponding thereto.

The particle information generation unit may sort the particle reference information in an ascending order based on the cell index. Referring to FIG. 3C, the particle information generation unit may sort particle reference information for each of the plurality of particles stored in the memory 310 in ascending order based on the cell index 312 of 0 and 1 or more.

The cell information generation unit may generate cell reference information regarding the plurality of cells. The cell reference information may include inclusion information and accumulation information.

The cell information generation unit may secure the memory based on the number of plurality of cells before generating the cell reference information. For example, the cell information generation unit may secure a memory capable of storing information corresponding to the total number of cells. The cell reference information corresponding to one cell may use a memory storing one piece of information.

The cell information generation unit may generate the inclusion information based on the cell index and the number of particles included in a cell corresponding to each cell index. Referring to FIGS. 3A and 3D, the cell information generation unit may secure a memory capable of storing nine pieces of information, which is the total number of cells. The cell information generation unit may generate inclusion information 321 based on the number of particles included in a cell corresponding to each cell index 320. For example, since there are two particles included in a cell corresponding to cell index 3, the inclusion information may be generated as ‘2’.

The cell information generation unit may generate the accumulation information based on the number of particles included in the cell corresponding to the cell index before each cell index. Referring back to FIGS. 3A and 3D, the cell information generation unit may generate accumulation information 322 based on the number of particles included in the cell corresponding to the cell index before each cell index 320. For example, since there is one particle included in the cell corresponding to the cell index before cell index 2, i.e., cell index 0, and there is one particle included in the cell corresponding to cell index 1, the accumulation information of cell index 2 may be generated as ‘2’.

The particle search unit 230 may search for at least one neighboring particle adjacent to the target particle based on the aforementioned particle reference information and cell reference information. The search for neighboring particles may be used to exchange particles among a plurality of processors to be described later. In addition, the search for neighboring particles may be used to calculate flow data to be described later.

The particle search unit 230 may search for a neighboring cell based on a cell index corresponding to a cell in which the target particle is positioned. Referring back to FIG. 3A, for example, with respect to a target particle having particle index 1, the neighboring cell may be derived as cells corresponding to cell indexes 0, 1, 2, 3, 5, 6, 7, and 8 based on 4 which is the cell index of the cell in which the target particle is positioned.

The particle search unit 230 may search for the neighboring particle based on the cell reference information corresponding to the cell in which the target particle is positioned.

The particle search unit 230 may search for the neighboring particle based on the cell reference information corresponding to the neighboring cell. The particle search unit 230 may search for the neighboring particle based on the inclusion information and the accumulation information of the neighboring cell. For example, when a plurality of neighboring cells is derived with respect to a target particle, the neighboring particle may be searched based on inclusion information and accumulation information of each neighboring cell.

The particle search unit 230 may track a first memory location of the particle reference information corresponding to the neighboring particle based on the accumulation information corresponding to the neighboring cell. The particle search unit 230 may track a plurality of second memory locations of the particle reference information corresponding to the neighboring particle based on the inclusion information corresponding to the neighboring cell.

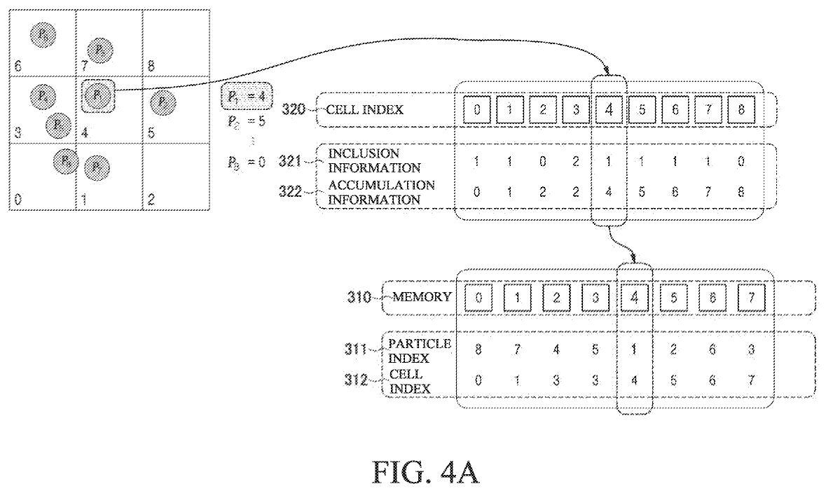

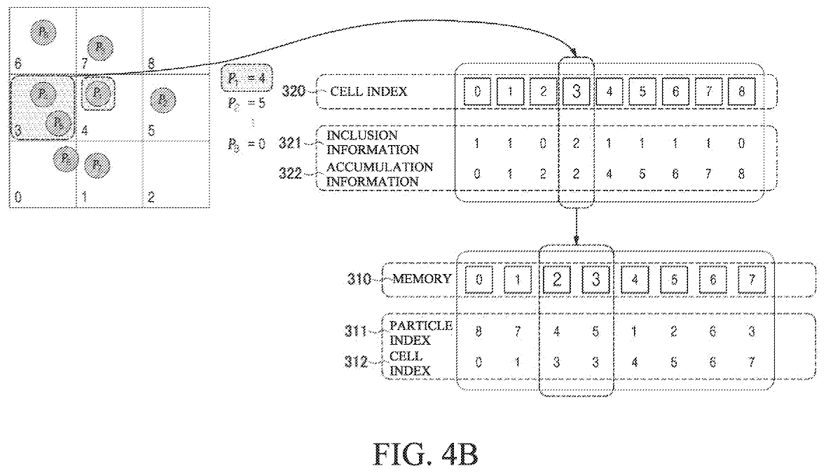

FIG. 4 is a diagram for describing a method for searching for a neighboring particle according to an embodiment of the present invention. FIGS. 4A and 4B exemplarily illustrate a process of searching for a neighboring particle of a target particle having a particle index of 1. By the above-described method, the neighboring cell of the target particle having the particle index of 1 may be derived as cells corresponding to cell indexes 0, 1, 2, 3, 5, 6, 7, and 8 based on 4 which is the cell index of the cell in which the target particle is positioned. The particle search unit 230 may search for the neighboring particle of the target particle based on the corresponding cell reference information with respect to each of the cell in which the target particle is positioned and the derived neighboring cell.

Referring to FIG. 4A, the fluid analysis simulation apparatus 100 may search for neighboring particles in the same cell based on the cell reference information corresponding to the cell (cell index 4) in which the target particle is positioned. The fluid analysis simulation apparatus 100 may extract accumulation information 4 corresponding to the cell having the cell index of 4. From this, the fluid analysis simulation apparatus 100 may track that the first memory location of the particle reference information corresponding to the neighboring particle in the same cell is ‘4’.

Further, the fluid analysis simulation apparatus 100 may extract inclusion information 1 corresponding to the cell having the cell index of 4. From this, the fluid analysis simulation apparatus 100 may track that the second memory location of the particle reference information corresponding to the neighboring particle in the same cell. The second memory location means a location of a plurality of additional memories that may contain one particle, including the particle corresponding to the first memory location. In FIG. 4A, since the inclusion information is ‘1’, only the target particle is positioned in the cell having the cell index of 4, and thus the second memory location is not tracked.

Through this, the fluid analysis simulation apparatus 100 may extract particle index 1 included in the cell having the cell index of 4 based on the tracked first and second memory locations. That is, the fluid analysis simulation apparatus 100 may confirm that only the particle included in the neighboring cell having the cell index of 4 is itself.

Referring to FIG. 4B, the fluid analysis simulation apparatus 100 may search for neighboring particles in the neighboring cell based on the cell reference information corresponding to a cell in which the cell index 320 is 3 among the neighboring cells of the target particle. The fluid analysis simulation apparatus 100 may extract accumulation information 2 corresponding to the neighboring cell in which the cell index is 3. Here, accumulation information 2 indicates that there are two particles in a plurality of cells corresponding to cell indexes (i.e., cell indexes 0 to 2) before cell index 3. From this, the fluid analysis simulation apparatus 100 may track that the first memory location of the particle reference information corresponding to the neighboring particle in the neighboring cell.

That is, the fluid analysis simulation apparatus 100 may confirm the location (i.e., first memory location) of memory 2 including information on a third particle which exists in cell index 3 based on accumulation information 2, and extract particle index 4 of the neighboring particle from memory 2.

Further, the fluid analysis simulation apparatus 100 may extract inclusion information 2 corresponding to the neighboring cell in which the cell index is 3. Here, inclusion information 2 indicates that two particles exist in cell index 3. From this, the fluid analysis simulation apparatus 100 may track the second memory location of the particle reference information corresponding to the neighboring particle in the neighboring cell. The second memory location means a location of a plurality of additional memories that may contain two particles, including the particle corresponding to the first memory location. That is, the fluid analysis simulation apparatus 100 may confirm the location (i.e., second memory location) of memory 3 including information on a fourth particle which exists in cell index 3 based on inclusion information 2, and extract particle index 5 of the neighboring particle from memory 3.

Through this, the fluid analysis simulation apparatus 100 may extract particle indexes 4 and 5 included in the neighboring cell having the cell index of 3 based on the tracked first and second memory locations. That is, the fluid analysis simulation apparatus 100 may confirm that particles included in the neighboring cell having the cell index of 3 are particles corresponding to particle indexes 4 and 5.

The fluid analysis simulation apparatus 100 may search for all the neighboring particles by repeating the above-described process with respect to the cell in which the target particle is positioned and all cells adjacent thereto, that is, cell indexes 0 to 8.

As described above, the fluid analysis simulation apparatus 100 may utilize the inclusion information and the accumulation information in searching for the neighboring particles of the target particle. That is, the particle reference information is sorted in ascending order based on the cell index, and the accumulation information is generated based on the number of particles included in the cell corresponding to the cell index before each cell index, so the fluid analysis simulation apparatus 100 may easily confirm the neighboring particles of the target particle by utilizing the inclusion information and the accumulation information.

More specifically, the fluid analysis simulation apparatus 100 may know a memory including information on the neighboring particle by using inclusion information and accumulation information corresponding to the neighboring cell of the cell in which the target particle is positioned without a need for inquiring all memories including particle information in order to search for the neighboring particles of the target particle, and confirm the information on the neighboring particle by inquiring only the corresponding memory. As a result, a processing speed of the fluid analysis simulation apparatus 100 may be significantly enhanced.

A space in which the plurality of particles exists may include a first space and a second space. Referring back to FIG. 1, the fluid analysis simulation apparatus 100 may allocate the first space to the first processor 110 and the second space to the second processor 120, for example.

As described above, each of the first processor 110 and the second processor 120 may include a space forming unit 220, a particle search unit 230, a particle exchange performing unit 260, and a flow data calculation unit 270.

Accordingly, the space forming unit 220 of the first processor 110 may partition the first space into the plurality of cells, and the cell information generation unit of the first processor 110 may generate first cell reference information based on information on the plurality of cells into which the first space is partitioned. The particle information generation unit of the first processor 110 may generate first particle reference information based on information on a particle included in the first space.

Similarly, the space forming unit 220 of the second processor 120 may partition the second space into the plurality of cells, and the cell information generation unit of the second processor 120 may generate second cell reference information based on information on the plurality of cells into which the second space is partitioned. The particle information generation unit of the second processor 120 may generate second particle reference information based on information on a particle included in the second space.

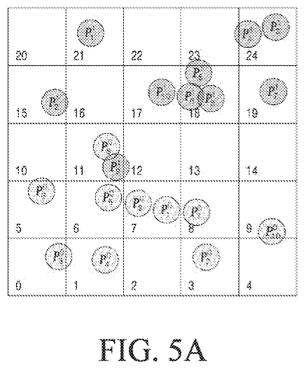

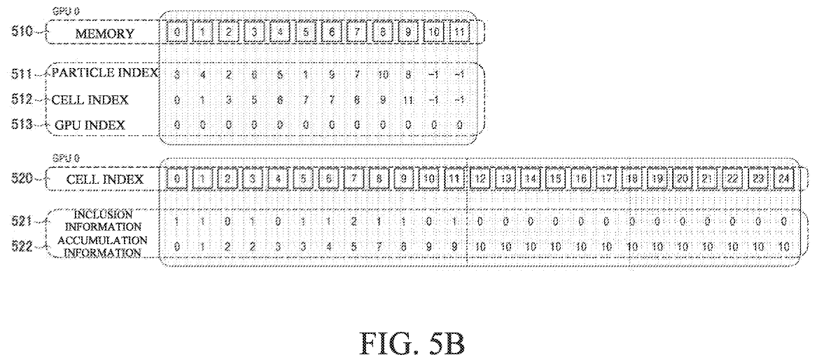

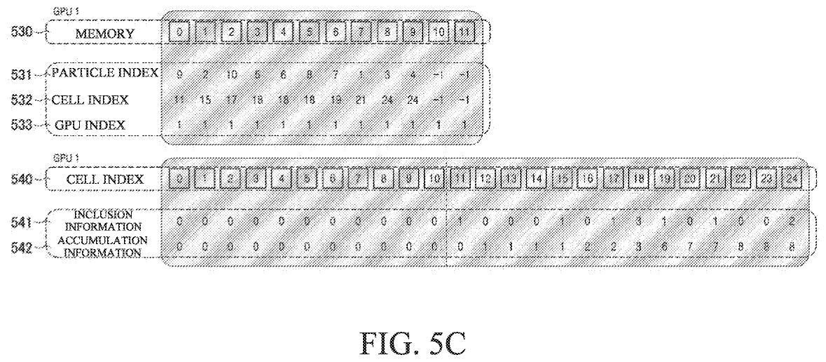

FIG. 5 exemplarily illustrates particle reference information and cell reference information generated by each of a plurality of processors according to an embodiment of the present invention.

Referring to FIGS. 5A and 5B, first cell reference information 520 to 522 generated based on information on cells corresponding to cell indexes 0 to 11 included in the first space by the first processor 110 is illustrated. Further, first particle reference information 510 to 513 generated based on the information of the particles P⁰₁ to P⁰₁₀ included in the first space by the first processor 110 is illustrated.

Referring to FIGS. 5A and 5C, second cell reference information 540 to 542 generated based on information on cells corresponding to cell indexes 11 to 24 included in the second space by the second processor 120 is illustrated. Further, second particle reference information 530 to 533 generated based on information of the particles P¹₁ to P¹₁₀ included in the second space by the second processor 120 is illustrated.

Referring back to FIG. 1, the fluid analysis simulation apparatus 100 may include a third processor 130. As described above, the third processor 130 may include an input unit 210, a cell management unit 240, and a particle management unit 250.

The cell management unit 240 of the third processor 130 may include an integrated cell information generation unit (not illustrated). The integrated cell information generation unit of the third processor 130 may generate integrated cell reference information based on the first cell reference information and the second cell reference information.

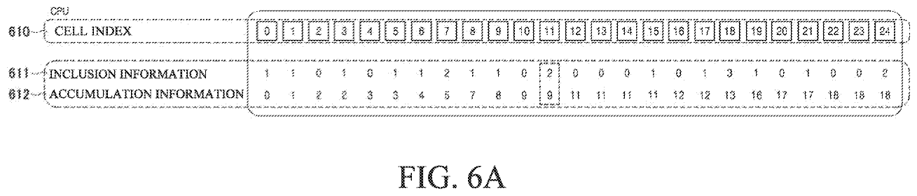

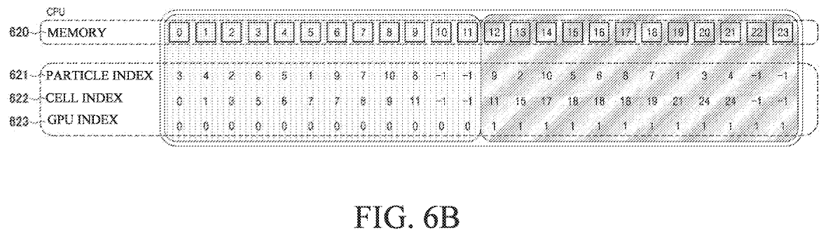

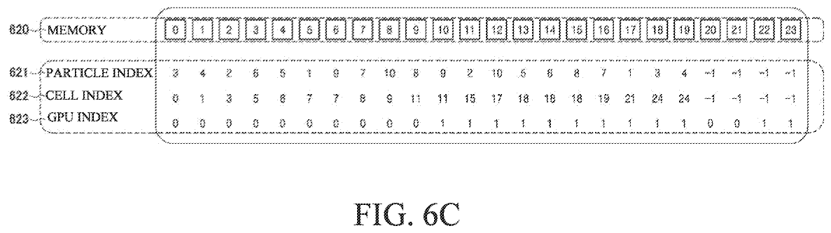

Referring to FIGS. 5A and 6A, the integrated cell information generation unit of the third processor 130 may generate integrated cell reference information 610 to 612 based on the first cell reference information (520 to 522 in FIG. 5B) generated by the first processor 110 and the second cell reference information (540 to 542 in FIG. 5C) generated by the second processor 120. For example, the integrated cell information generation unit of the third processor 130 may generate the integrated cell reference information by summing inclusion information of cells corresponding to the same cell index and summing accumulation information of cells corresponding to the same cell index, respectively.

The particle management unit 250 of the third processor 130 may include an integrated particle information generation unit (not illustrated). The integrated particle information generation unit of the third processor 130 may generate integrated particle reference information based on the first particle reference information and the second particle reference information.

Referring to FIGS. 5A and 6B, the integrated particle information generation unit of the third processor 130 may generate integrated particle reference information 620 to 623 based on the first particle reference information (510 to 513 in FIG. 5B) generated by the first processor 110 and the second particle reference information (530 to 533 in FIG. 5C) generated by the second processor 120. For example, the integrated particle information generation unit of the third processor 130 may generate the integrated particle reference information by storing the first particle reference information and the second particle reference information in parallel.

The integrated particle information generation unit of the third processor 130 may sort the integrated particle reference information in ascending order based on the cell index. Referring to FIG. 6C, the integrated particle information generation unit may sort integrated particle reference information for each of the plurality of particles stored in the memory 620 in ascending order based on a cell index 622 of 0 and 1 or more.

The cell management unit 240 of the third processor 130 may further include a region allocation unit (not illustrated). The region allocation unit of the third processor 130 may derive the number of particles positioned in the first space and the number of particles positioned in the second space based on the integrated cell reference information. The region allocation unit of the third processor 130 may allocate the first space to the first processor 110 and allocate the second space to the second processor 120 based on the number of particles positioned in the first space and the number of particles positioned in the second space.

Referring back to FIG. 6A, the region allocation unit of the third processor 130 may allocate the space to each processor based on the number of plurality of particles based on accumulation information 612 of the integrated cell reference information.

The particle management unit 250 of the third processor 130 may further include a particle exchange unit (not illustrated). The particle exchange unit of the third processor 130 may identify an exchange target particle based on the second cell reference information. That is, the particle exchange unit of the third processor 130 may confirm the exchange target particle based on the space allocated to each processor.

The particle exchange unit of the third processor 130 may extract information on the exchange target particle from the second particle reference information based on the accumulation information of the second cell reference information. The particle exchange unit of the third processor 130 may instruct the movement of the exchange target particle to the first processor based on the information on the exchange target particle.

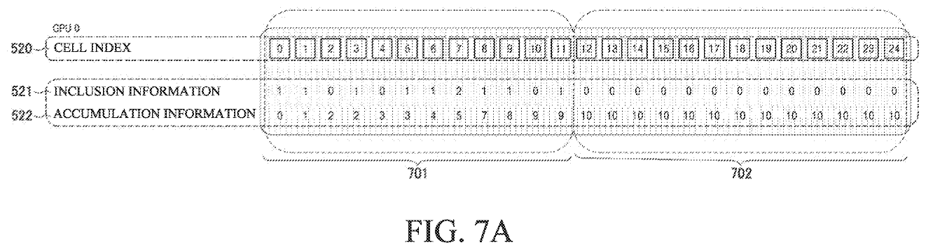

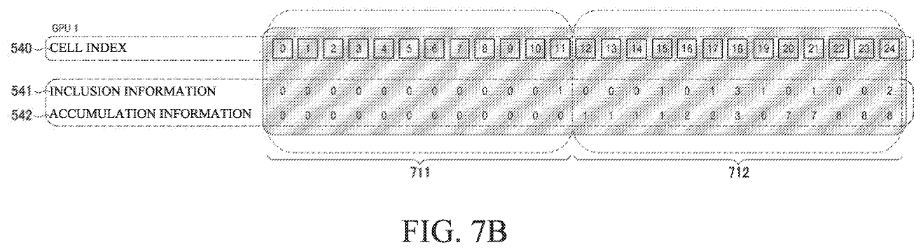

Referring to FIGS. 5B and 7A, the particle exchange unit of the third processor 130 may extract, from the first cell reference information 520 to 522, memory information 701 for a cell in which a particle which is not an exchange target is present and memory information 702 for a cell in which the exchange target particle is present. The particle exchange unit of the third processor 130 may confirm the exchange target particle based on the memory information 701. In this case, the exchange target particle as a particle which the first processor 110 manages through the first particle reference information 510 to 513 is a particle positioned in the cell allocated to the second processor 120. In FIG. 7A, a case where the exchange target particle is not present is illustrated.

Referring to FIGS. 5C and 7B, the particle exchange unit of the third processor 130 may extract, from the second cell reference information 540 to 542, memory information 711 for a cell in which the particle which is the exchange target is present and memory information 712 for a cell in which the particle which is not the exchange target is present. The particle exchange unit of the third processor 130 may confirm the exchange target particle based on the memory information 711. In this case, the exchange target particle as a particle which the second processor 120 manages through the second particle reference information 530 to 533 is a particle positioned in the cell allocated to the first processor 110. In FIG. 7B, a case where the exchange target particle is present in the cell corresponding to cell index 11 is illustrated.

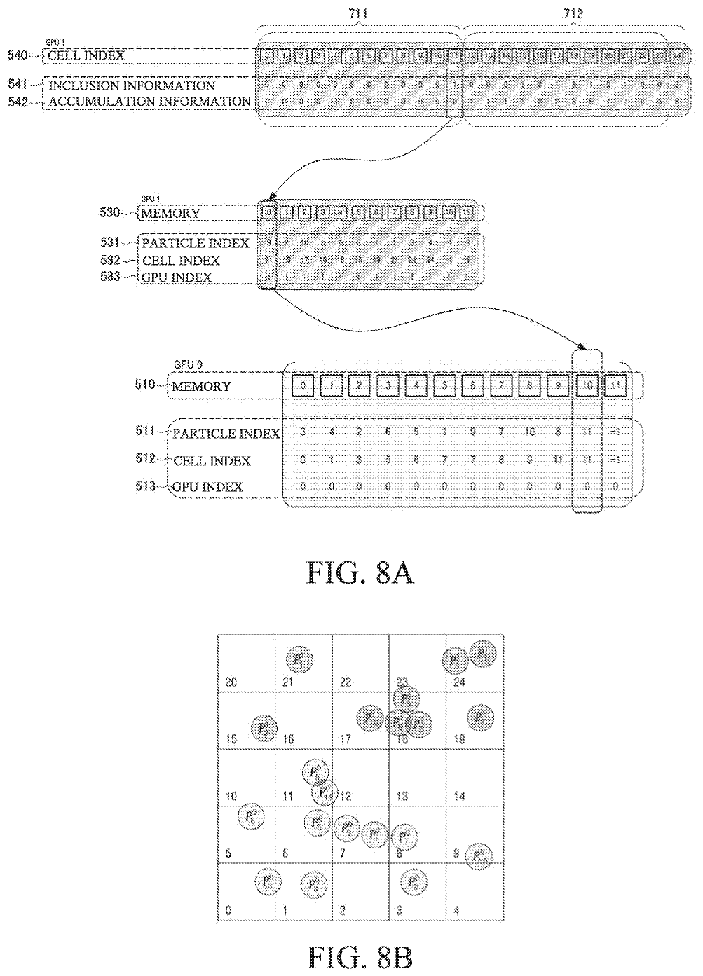

Referring to FIG. 8A, the particle exchange unit of the third processor 130 may track a memory location of the second particle reference information 530 to 533 from the second cell reference information 540 to 542 based on the memory information 711. The particle exchange unit of the third processor 130 may extract particle index 9 of the exchange target particle from the second particle reference information 540 to 542. For example, the particle exchange unit of the third processor 130 may track that the first memory location of the second particle reference information 530 to 533 in which the exchange target particle is present from the accumulation information ‘0’ corresponding to cell index ‘11’ in which the exchange target particle of the second particle reference information 540 to 542 is present. The particle exchange unit of the third processor 130 may track the second memory location of the second particle reference information 530 to 533 in which the exchange target particle is present from inclusion information ‘1’ corresponding to cell index ‘11’. In FIG. 8A, since the inclusion information is ‘1’, only the target particle is positioned in the cell having the cell index 11, and thus the second memory location is not tracked.

The particle exchange unit of the third processor 130 may instruct the movement of the exchange target particle to the first processor 110 based on the information on the exchange target particle. For example, the particle exchange unit of the third processor 130 may confirm particle index 9 of the exchange target particle from the memory corresponding to the first memory location of the second particle reference information 530 to 533, and instruct the second processor 120 to move the movement of information on the particle corresponding to particle index 9 to the first processor 110.

The particle exchange performing unit 260 of the first processor 110 may receive data regarding the exchange target particle from the second processor 120.

The particle information generation unit of the first processor 110 may update the first particle reference information based on the information on the exchange target particle. The cell information generation unit of the first processor 110 may update the first cell reference information based on the information on the exchange target particle.

Referring to FIGS. 8A and 8B, the particle information generation unit of the first processor 110 may receive the data regarding the particle corresponding to particle index 9, which is the exchange target particle, from the second processor 120, and update the first particle reference information 510 to 513. The particle information generation unit of the first processor 110 may update the first particle reference information 510 to 513 to include particle index 11 newly granted to the exchanged particle and cell index 11 of a cell including the exchanged particle. The cell information generator of the first processor 110 may update the inclusion information and the accumulation information of the first cell reference information as the particle corresponding to particle index 11 is included in the cell corresponding to cell index 11.

The particle information generation unit of the second processor 120 may update the second particle reference information by deleting the particle corresponding to particle index 9, which is the exchange target particle, from the second particle reference information. The particle information generation unit of the second processor 120 may update the inclusion information and the accumulation information of the second cell reference information by deleting the particle corresponding to particle index 9, which is the exchange target particle, from the second particle reference information.

The flow data calculation unit 270 may calculate flow data generated due to a collision between each particle and the neighboring particle or a collision between each particle and a polygon constituting a structure model by using the SPH algorithm, and perform the fluid analysis simulation based on the flow data.

The SPH algorithm calculates the flow of each particle using physical property information (e.g., mass, velocity, viscosity, and acceleration) of each particle, and the physical property information of each particle is interpolated by using a kernel function set such as a radial basis function around the location of the each particle.

When the physical property information of each particle is interpolated by such a scheme, continuous fields such as pressure and viscosity fields that may be used to calculate the dynamics of a fluid are generated by using standard equation such as the Navier-Stokes Equation.

For example, the Navier-Stokes equation models the fluid as follows.

$$ρ ( ( \frac{\partial ν}{\partial t} ) + v \cdot ∇ v ) = ρ g - ∇ p + μ {∇}^{2} v \qquad [ Equation 1 ]$$

In Equation 2, “v” represents the velocity of the particle, “ρ” represents the density of the particle, “p” represents the pressure on the particle, “g” represents the gravity, and “μ” represents the viscosity coefficient of the fluid.

Meanwhile, according to the SPH algorithm, the density of each particle is derived by Equation 2.

$$ρ ( {x}_{i} ) = {\sum }_{j} {m}_{j} W ( {x}_{i} - {x}_{j} , h ) \qquad [ Equation 2 ]$$

Further, force by the pressure of each particle is derived by Equation 3.

$${f}_{i}^{pressure} = - {\sum }_{j} {m}_{j} \frac{{p}_{i} + {p}_{j}}{2 {ρ}_{j}} ∇ W ( {x}_{i} - {x}_{j} , h ) \qquad [ Equation 3 ]$$

Further, force by the viscosity of each particle is derived by Equation 4.

$${f}_{i}^{viscosity} = μ {\sum }_{j} {m}_{j} \frac{{v}_{j} - {v}_{i}}{{ρ}_{j}} {∇}^{2} W ( {x}_{i} - {x}_{j} , h ) \qquad [ Equation 4 ]$$

The flow data calculation unit 270 calculates change values of the flow data such as the density, the pressure, the viscosity, etc., of each particle by using the SPH algorithm. For example, the flow data calculation unit 270 calculates the flow data of each particle in a next time step (a second time step) based on initial flow data of each particle, and calculates the flow of each particle based thereon.

Further, the flow data calculation unit 270 calculates the flow data of each particle in a next time step based on the flow data of each particle in the second time step, and calculates the flow of each particle based thereon.

The flow data calculation unit 270 may perform the fluid analysis simulation by calculating the flow of each particle by calculating the flow data of each particle in each time step.

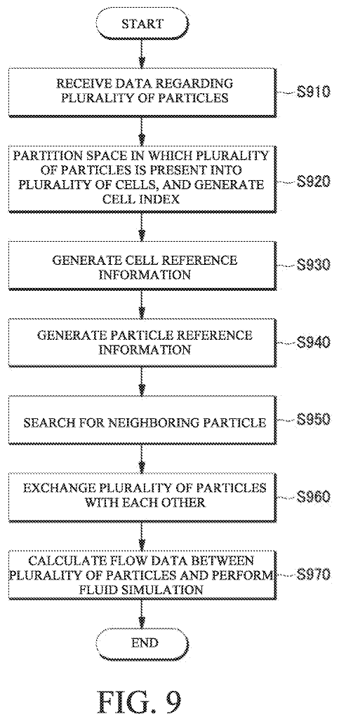

FIG. 9 is a flowchart of a fluid analysis simulation method according to an embodiment of the present invention. A fluid analysis simulation method 900 performed by the fluid analysis simulation apparatus 100 illustrated in FIG. 9 includes steps processed in time series by the fluid analysis simulation apparatus 100 according to the embodiment illustrated in FIG. 2. Accordingly, even contents omitted below are applied to the fluid analysis simulation method performed by the fluid analysis simulation apparatus 100 according to the embodiment illustrated in FIG. 2.

In step S920, the fluid analysis simulation apparatus 100 may receive data regarding a plurality of particles.

In step S920, the fluid analysis simulation apparatus 100 may partition a space in which a plurality of particles is present into a plurality of cells, and generate a cell index.

In step 930, the fluid analysis simulation apparatus 100 may generate cell reference information.

In step 940, the fluid analysis simulation apparatus 100 may generate particle reference information.

In step S950, the fluid analysis simulation apparatus 100 may search for a neighboring particle.

In step S960, the fluid analysis simulation apparatus 100 may exchange the plurality of particles with each other.

In step S970, the fluid analysis simulation apparatus 100 may calculate flow data between the plurality of particles, and perform a fluid simulation.

In the above description, steps S920 to S970 may be further divided into additional steps or combined into fewer steps, according to an embodiment of the present invention. In addition, some steps may be omitted as necessary, and the order between the steps may be switched.

The method of performing fluid analysis simulation in the fluid analysis simulation apparatus described through FIGS. 2 to 9 may be implemented in the form of a computer program stored in a medium executed by a computer or a recording medium including instructions executable by the computer. Further, the method of performing fluid analysis simulation in the fluid analysis simulation apparatus described through FIGS. 2 to 9 may also be implemented in the form of the computer program stored in the medium executed by the computer.

A computer readable medium may be a predetermined available medium accessible by the computer or includes all of volatile and non-volatile media and removable and irremovable media. Further, the computer readable medium may include a computer storage medium. The computer storage medium includes all of the volatile and non-volatile and removable and irremovable media implemented by a predetermined method or technology for storing information such as a computer readable command, a data structure, a program module, or other data.

The aforementioned description of the present invention is used for exemplification, and it may be understood by those skilled in the art that the present invention may be easily modified in other detailed forms without changing the technical spirit or requisite features of the present invention. Therefore, it should be appreciated that the aforementioned embodiments are illustrative in all aspects and are not restricted. For example, respective constituent elements described as single types may be distributed and implemented, and similarly, constituent elements described to be distributed may also be implemented in a coupled form.

The scope of the present invention is represented by claims to be described below rather than the detailed description, and it is to be interpreted that the meaning and scope of the claims and all the changes or modified forms derived from the equivalents thereof come within the scope of the present invention.

What is claimed is:

1. A smoothed particle hydrodynamics (SPH)-based fluid analysis simulation apparatus using a plurality of processors, comprising:
a first processor; and
a second processor,
wherein the first processor partitions a first space allocated to the first processor into a plurality of cells, generates first cell reference information based on information on the plurality of cells into which the first space is partitioned, generates first particle reference information based on information on a particle included in the first space, the second processor partitions into a second space allocated to the second processor into the plurality of cells, generates second cell reference information based on information on the plurality of cells into which the second space is partitioned, and generates second particle reference information based on information on the particle included in the second space, and the first processor and the second processor exchange the plurality of particles based on the first cell reference information, the first particle reference information, the second cell reference information, and the second particle reference information, calculate flow data between the plurality of exchanged particles, and performs a fluid simulation based on the flow data.

2. The SPH-based fluid analysis simulation apparatus of claim 1, wherein the first processor includes a particle information generation unit generating the first particle reference information based on location information of the plurality of particles and a cell index for the first space, and a cell information generation unit generating the first cell reference information including inclusion information generated based on each cell index and the number of particles included a cell corresponding to each cell index.

3. The SPH-based fluid analysis simulation apparatus of claim 2, wherein the cell reference information further includes accumulation information generated based on the number of particles included in a cell corresponding to a cell index before each cell index.

4. The SPH-based fluid analysis simulation apparatus of claim 3, wherein the fluid analysis simulation apparatus further includes a third processor, and
the third processor includes a cell management unit including an integrated cell information generation unit generating integrated cell reference information based on the first cell reference information and the second cell reference information, and a particle management unit including an integrated particle information generation unit generating integrated particle reference information based on the first particle reference information and the second particle reference information.

5. The SPH-based fluid analysis simulation apparatus of claim 4, wherein the cell management unit further includes a region allocation unit deriving the number of particles positioned in the first space and the number of particles positioned in the second space based on the integrated cell reference information, and allocating the first space to the first processor and allocating the second space to the second processor based on the number of particles positioned in the first space and the number of particles positioned in the second space.

6. The SPH-based fluid analysis simulation apparatus of claim 4, wherein the particle management unit further includes a particle exchange unit confirming an exchange target particle based on the second cell reference information, extracting information on the exchange target particle from the second particle reference information based on accumulation information of the second cell reference information, and instructing movement of the exchange target particle to the first processor based on the information on the exchange target particle.

7. The SPH-based fluid analysis simulation apparatus of claim 6, wherein the first processor further includes a particle exchange performing unit receiving data regarding the exchange target particle from the second processor.

8. The SPH-based fluid analysis simulation apparatus of claim 7, wherein the particle information generation unit updates the first particle reference information based on the information on the exchange target particle and the cell information generation unit updates the first cell reference information based on the information on the exchange target particle.

9. The SPH-based fluid analysis simulation apparatus of claim 4, wherein the first and second processors are graphics processing units (GPU) and the third processor is a central processing unit (CPU).

10. A fluid analysis simulation method performed by a smoothed particle hydrodynamics (SPH)-based fluid analysis simulation apparatus including a first processor and a second processor, the method comprising:
partitioning, by the first processor, a first space allocated to the first processor into a plurality of cells;
generating, by the first processor, first cell reference information based on information on the plurality of cells into which the first space is partitioned;
generating, by the first processor, first particle reference information based on information on a particle included in the first space;
partitioning, by the second processor, a second space allocated to the second processor into the plurality of cells;
generating, by the second processor, second cell reference information based on information on the plurality of cells into which the second space is partitioned;
generating, by the second processor, second particle reference information based on information on a particle included in the second space;
exchanging, by each of the first processor and the second processor, the plurality of particles based on the first cell reference information, the first particle reference information, the second cell reference information, and the second particle reference information; and
calculating, by each of the first processor and the second processor, flow data between the plurality of exchanged particles, and performing a fluid simulation based on the flow data.

11. The fluid analysis simulation method of claim 10, comprising:
generating, by the first processor, the first particle reference information based on location information of the plurality of particles and a cell index for the first space; and
generating, by the first processor, the first cell reference information including inclusion information generated based on the cell index and the number of particles included a cell corresponding to each cell index.

12. The fluid analysis simulation method of claim 11, wherein the cell reference information further includes accumulation information generated based on the number of particles included in a cell corresponding to a cell index before each cell index.

13. The fluid analysis simulation method of claim 12, wherein the fluid analysis simulation apparatus further includes a third processor, and
the fluid analysis simulation method includes
generating, by the third processor, integrated cell reference information based on the first cell reference information and the second cell reference information; and
generating, by the third processor, integrated particle reference information based on the first particle reference information and the second particle reference information.

14. The fluid analysis simulation method of claim 13, further comprising:
deriving, by the third processor, the number of particles positioned in the first space and the number of particles positioned in the second space based on the integrated cell reference information; and
allocating, by the third processor, the first space to the first processor and allocating the second space to the second processor based on the number of particles positioned in the first space and the number of particles positioned in the second space.

15. The fluid analysis simulation method of claim 13, further comprising:
confirming, by the third processor, an exchange target particle based on the second cell reference information;
extracting, by the third processor, information on the exchange target particle from the second particle reference information based on accumulation information of the second cell reference information; and
instructing, by the third processor, movement of the exchange target particle to the first processor based on the information on the exchange target particle.

16. The fluid analysis simulation method of claim 15, further comprising:
receiving, by the first processor, data regarding the exchange target particle from the second processor.

17. The fluid analysis simulation method of claim 16, further comprising:
updating, by the first processor, the first particle reference information based on the information on the exchange target particle; and
updating, by the first processor, the first cell reference information based on the information on the exchange target particle.

18. The fluid analysis simulation method of claim 13, wherein the first and second processors are graphics processing units (GPU) and the third processor is a central processing unit (CPU).

19. A computer program stored in a medium including a sequence of instructions of performing a smoothed particle hydrodynamics (SPH)-based fluid analysis simulation using a plurality of processors, wherein
when the computer program is executed by a computing device,
the plurality of processors includes a first processor and a second processor, divides an analysis space into a first space and a second space, allocates the first space to the first processor, and allocates the second space to the second processor, and includes a sequence of instructions of instructing partitioning, by the first processor, the first space into a plurality of cells, generating, by the first processor, first cell reference information based on information on the plurality of cells into which the first space is partitioned, generating, by the first processor, first particle reference information based on information on a particle included in the first space, partitioning, by the second processor, the second space into the plurality of cells, generating, by the second processor, second cell reference information based on information on the plurality of cells into which the second space is partitioned, generating, by the second processor, second particle reference information based on information on a particle included in the second space, and exchanging, by each of the first processor and the second processor, the plurality of particles based on the first cell reference information, the first particle reference information, the second cell reference information, and the second particle reference information, and calculating, by each of the first processor and the second processor, flow data between the plurality of exchanged particles, and performing a fluid simulation based on the flow data.
